(19) United States
(12) Patent Application Publication
(10) Pub. No.: US 2007/0055928 A1
(43) Pub. Date: Mar. 8, 2007

(54) User workflow lists to organize multimedia files

(75) Inventors: Benjamin L. Pery, Seattle, WA (US); David R. Parlin, Redmond, WA (US); Jae Pum Park, Redmond, WA (US); Mark A. Nikiel, Redmond, WA (US); Scott E. Dart, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/217,488

(22) Filed: Sep. 2, 2005

(51) Int. Cl. G06F 17/24

(52) U.S. Cl. 715/514; 715/513

(57) ABSTRACT

A method to organize multimedia files in a hierarchy having a plurality of nodes is provided. The nodes of the hierarchy are lists that store references to the multimedia files. Additionally, each node of the hierarchy is associated with properties representing activities to be performed on the multimedia files. The multimedia files are stored in the lists associated with activities that the multimedia files require. Accordingly, the multimedia files are organized based on a relationship between the activities and each multimedia file.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

Currently, images are organized based on inherent characteristics that define the images' quality. The inherent characteristics, such as, resolution or Red-Green-Blue (RGB) values, are utilized to organize images into groups that have similar RGB values or resolutions. Organizing the images using the inherent characteristics is useful only when a user cares about the images having a particular resolution or RGB value. The inherent characteristics provide a static snapshot of what the user may care about, but fail to reflect a users actual and current interests. For instance, if the user is interested in locating images that need to be touched up or printed, an organization of images having similar resolutions or RGB values may not be a proper representation of the images that need to be touched up or printed. These and other limitations of the current image organization techniques decrease the user's satisfaction when attempting to locate images that interest the user.

### SUMMARY

User workflow lists provide efficient methods to organize multimedia files. The user workflow lists are associated with activities and arranged in a hierarchy to provide an arrangement that presents the multimedia files in a flexible and dynamic structure. The user workflow lists include properties that define interactions between the user workflow lists and the multimedia files. Additionally, each user workflow list provides membership lists that have references to multimedia files that are members of each user workflow list. The user workflow lists organize multimedia files based on the activities associated with the user workflow list and may be searched to display the multimedia files or activities and properties related to multimedia files.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a block diagram of an exemplary computing environment utilized by embodiments of the invention;

FIG. 2 illustrates a storage model that defines user workflow lists generated by embodiments of the invention;

FIG. 3 illustrates a graphical user interface utilized to display multimedia files stored in the user workflow lists;

FIG. 4 illustrates a user workflow lists hierarchy utilized by embodiments of the invention;

FIG. 5 illustrates a thumbnail of a user workflow list utilized by embodiments of the invention;

FIG. 6 illustrates a user workflow list properties dialog box utilized by embodiments of the invention;

FIG. 7 illustrates a flow diagram of a method to organize multimedia files utilizing the user workflow lists; and

FIG. 8 illustrates a flow diagram of a method to track membership of multimedia files utilizing the user workflow lists.

### DETAILED DESCRIPTION

Embodiments of the invention provide user workflow lists that efficiently organize multimedia files according to activities associated with the user workflow lists. The user workflow lists are dynamic and expandable to include activities that are of interest to the user at anytime in the future. The user workflow lists are associated with properties that define activities, which may be searched to display the multimedia files related to one or more activities. Accordingly, embodiments of the invention provide an efficient way to create and retrieve user workflow lists that are associated with activities to be performed on the multimedia files.

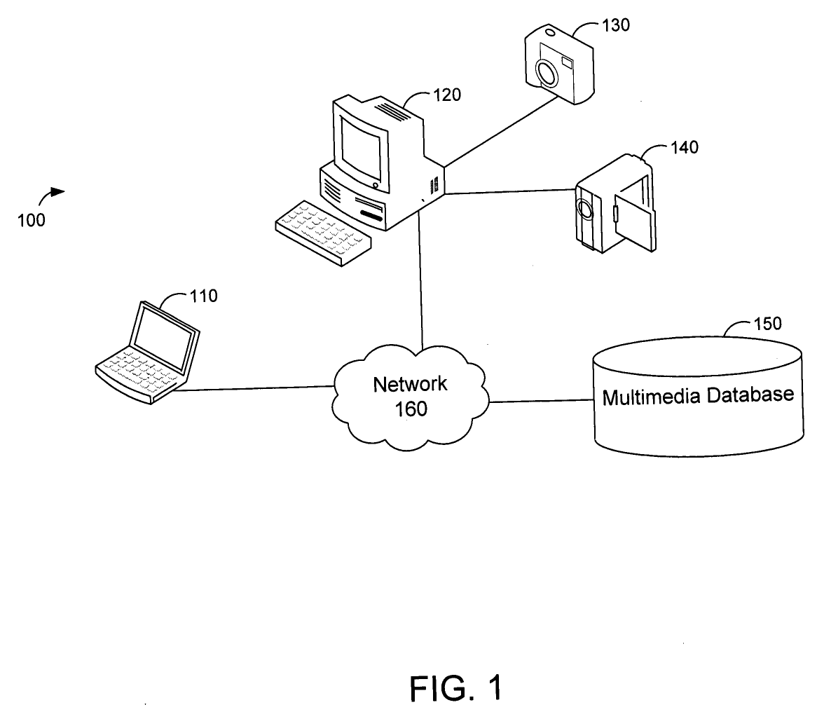

FIG. 1 illustrates a block diagram of an exemplary computing environment 100 utilized by embodiments of the invention. The computing environment 100 is not intended to suggest any limitation as to scope or functionality. Embodiments of the invention are operable with numerous other special purpose computing environments or configurations. With reference to FIG. 1, the computing environment 100 includes client computers 110-120, image capture devices 130-140, a multimedia database 150 and a communication network 160.

The client computers 110-120 each have processing units, coupled to a variety of input devices and computer-readable media via communication buses. The computer-readable media may include computer storage and communication media that are removable or non-removable and volatile or non-volatile. By way of example, and not limitation, computer storage media includes electronic storage devices, optical storages devices, magnetic storage devices, or any medium used to store information that can be accessed by client computers 110-120, and communication media may include wired and wireless media. The input devices may include, mice, keyboards, joysticks, controllers, microphones, cameras 130, camcorders 140, or any suitable device for providing user input to the client computers 110-120.

Additionally, the client computers 110-120 may store application programs that provide computer-readable instructions to implement various heuristics. In an embodiment of the invention, the client computers 110-120 store user workflow lists that organize multimedia files. The multimedia files may be image or video files that are captured on the camera 130 or camcorder 140 and communicated directly to the client computers 110-120 to store the multimedia files in user the workflow lists. Also, multimedia files stored in a multimedia database 150 that communicates with the client computers 110-120 over the communication network 160 are stored in the user workflow lists. The user workflow lists may be stored in an Extensible Markup Language (XML) format. The communication network 160 may be a local area network, a wide area network, or the Internet. The client computers 110-120 may include laptops, smart phones, personal digital assistants, and desktop computers. The computing environment illustrated in FIG. 1 is exemplary and other configurations are within the scope of the invention.

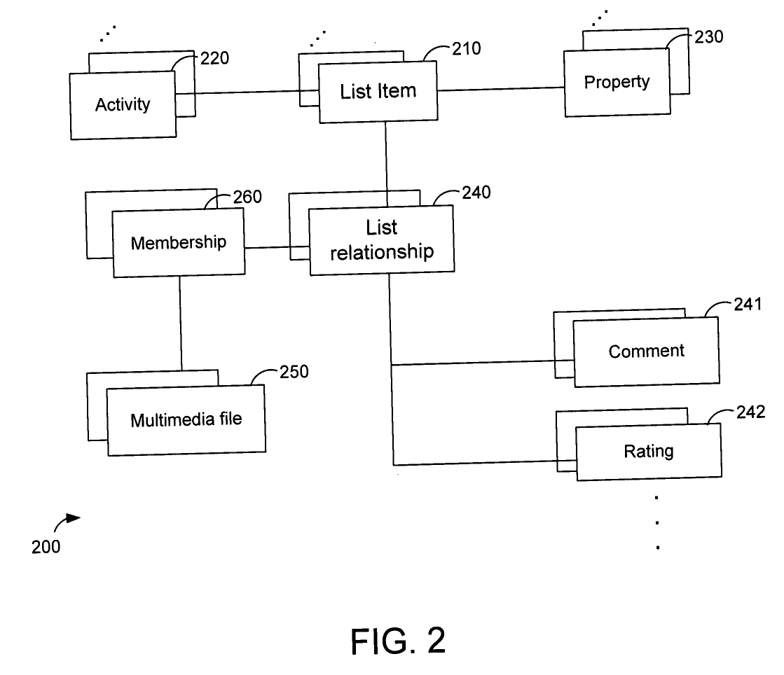

FIG. 2 illustrates a storage model that defines the user workflow lists generated by embodiments of the invention. The user workflow lists include list items 210, activities 220, properties 230, list relationships 240, metadata 241-242, multimedia files 250, and memberships 260.

The list items 210 are building blocks for each user workflow list and may be nodes of a hierarchy. The list item 210 is a data container that includes activities 220 and properties 230 that define the user workflow list. The activities 220 may include user defined activities, such as, for example, “For Review,” “To Print,” or “Needs Touchup,” etc. The properties 230 may include list information, such as, the number of multimedia files, date of creation, size, etc.

The list item 210 also includes a list relationship 240 that provides membership 260, location data for multimedia files 250, and metadata 241-242. The list relationship 240 associates the multimedia files 250 with the list item 210. The membership 260 stores a reference to the multimedia files 250 that are associated with the list item 210. In an embodiment of the invention, a user may associate one or more multimedia files with the list item 210 via drag-and-drop commands. The multimedia file 250 may be an image file or a video file, and the list relationship 240 may store the actual multimedia file 250 or a reference to the multimedia file 250. The metadata 241-242 includes information that describes the multimedia file, such as, for example, a comment 241, file name, or a rating 242. The metadata is list-specific, and includes information that applies to the multimedia file in the context of the workflow list associated with the multimedia file. The comment 241 may be text specified by the user that reflects the users perception of the multimedia file. For instance, a comment associated with a “To Print” list may specify printing instructions that is particular to the multimedia file and the list. The rating 242 may be a number representing a user's affinity for the picture. The metadata may also include information about how to orchestrate a slideshow utilizing the multimedia files, as well as information defining optimal display settings for rendering the multimedia files 250. Additionally, the properties 230 may store information, lighting or monitor data, on optimal environments for rendering the multimedia files 250 associated with the user workflow list. Therefore, each list item 210 may be associated with one or more multimedia files 250, and the user workflow lists may include one or more list items 210 that define how to organize, display, or edit the multimedia files 250.

Moreover, in an embodiment of the invention, the user workflow lists preserve relationships between activities and multimedia files when the user workflow lists are transferred from client computer 120 to client computer 110. When a transfer is initiated the user workflow list on client computer 120 is serialized into a binary large object (blob), which represents a duplicate of the user workflow list. Then the blob is deserialized into another user workflow list and stored by client computer 110. The user workflow list on client computer 120 is converted into a shortcut or proxy user workflow list for the user workflow list on client computer 110. The proxy user workflow list points, or links, to the user workflow list on client computer 110 but does not contain all of the substantive data. Thus, by creating the proxy user workflow list, a user on client computer 120 can access the user workflow list on client computer 110 as though it were never affected by the transfer operation. Also, by replacing or converting the user workflow list on client computer 120 into the proxy user workflow list, storage space on client computer 120 is freed. Therefore, the user workflows list can be imported, exported, or backed-up among different client computers without destroying the relationships between the multimedia files and activities.

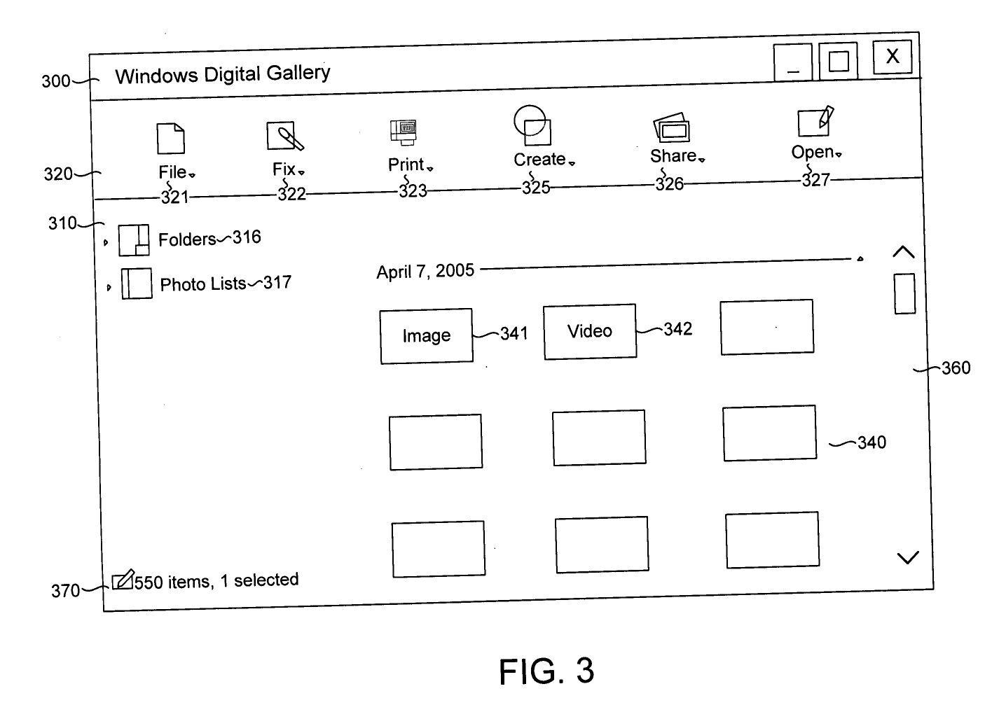

FIG. 3 illustrates a graphical user interface 300 utilized to display multimedia files stored in the user workflow lists. The graphical user interface 300 may provide access to digital libraries storing multimedia files. The graphical user interface 300 includes a navigation section 310, a file operations section 320 and a view section 340.

The navigation section 310 provides a tree hierarchy that provides collections of multimedia files organized under one or more nodes. The nodes of the tree hierarchy include, among other things, folders 316 and photo lists 317. The folders node 316 provides a hierarchy of folders having different storage paths that contain multimedia files. In an embodiment of invention, each folder in the hierarchy of folders is utilized by the client computer 120 to store the multimedia files. The photo lists node 317 presents a node that organizes the collection of multimedia files based on activities to be performed on the multimedia files. The photo list node 317 provides an expandable hierarchy that may include child nodes that represent other photo lists and activities related to the parent node. Each activity represents a node that is related to the photo list node 317. In an embodiment of the present invention, folders, and photo list nodes may represent root nodes or parent nodes and the nodes in the hierarchy under each of the root nodes are children nodes. Accordingly, the navigation section 310 provides a hierarchy of nodes that can be traversed to view the multimedia files based on properties or activities associated with the multimedia files.

The file operations section 320 provides a menu to perform various multimedia file operations. The operations include, among other things, file 321, fix 322, print 323, create 325, share 326, open 327, or navigate 329. The file operation 321 may include a slide show option that provides selections related to creating a slide show associated with multimedia files in the digital libraries. The fix operation 322 allows the user to edit a selected multimedia file. The print operation 323 provides the user with a print dialog box that allows the user to print one multimedia file or a group of multimedia files. The create operation 325 allows a user to create one or more multimedia files. The share operation 326 allows the client computer to share tags, lists, or multimedia files stored in the digital libraries. The open operation 327 allows the user to display one or more multimedia files. The user may utilize the operations in the file operations section 320 to manipulate one or more multimedia files.

The view section 340 provides a display area to view the multimedia files. The view section 340 may display an image, slideshow, a video, or thumbnails of the multimedia files stored in the digital libraries. In an embodiment of the invention, displaying the multimedia files provides a slideshow of all multimedia files stored in the digital library and associated with the photo lists node 317.

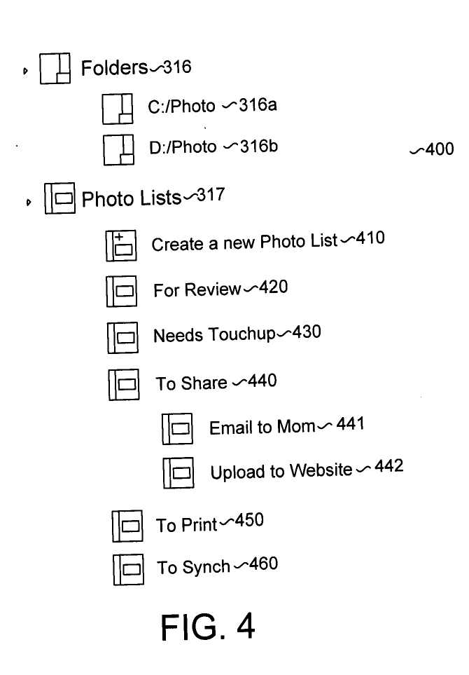

FIG. 4 illustrates a user workflow lists hierarchy 400 utilized by embodiments of the invention. The nodes 316-317 may represent root nodes of hierarchies that are related with one or more multimedia files. The folders node 316 include child nodes 316a and 316b that represent the storage locations for the multimedia files. The photo list node 317 provides a hierarchy that defines a user's perception of what activities should be performed on one or more multimedia files displayed in the view section 340. The photo list node 317 includes child nodes create a new photo list 410, for review 420, needs touch up 430, to share 440, to print 450, and to synch 460. Selecting any of the photo lists nodes 420-460 replaces the content of the view section 340 with the multimedia files that are members of the selected node.

The create new photo list node 410 is a dynamic activity node that enables a user to create new child nodes related to the photo list node 317. The user may create a new node by clicking on the create new photo list node 410 and typing a name corresponding to an activity to be performed on one or more multimedia files. For instance, the user can create an activity called “to delete” by clicking on the create new photo list node 410 and typing “to delete.” This adds a “to delete” node to the photo lists node 317. Alternately, the user may right-click on the photo lists node 317 and select an option that creates a new node.

A user may associate one or more multimedia files with the nodes 420-460 by dragging-and-dropping the multimedia file onto a node 420-460. A membership list associated with the nodes 420-460 is updated to reflect that one or more multimedia files have been associated with the nodes 420-460. For instance, for review node 420 includes all multimedia files that are set aside for review by the user. The user may determine that a multimedia file shown in the view section 340 should be included in the for review node 420. The user may select and drag one or more multimedia files to the for review node 420. The membership list associated with the for review node 420 is updated to include the one or more multimedia files.

Moreover, the user may create child photo lists by dragging a first photo list onto a second photo list. The first photo list will be the child photo list and the second photo list will be the parent photo list. In an embodiment of the invention, the second photo list may be the child list, or a dialog box may query the user to determine whether the list should be represented with a child or parent relationship. For instance, a user may create photo lists “Email to Mom” 441 and “Upload to Website” 442 which are related to a “To Share” photo list 440. Accordingly, dragging the photo lists 441 and 442 to the “To Share” photo list 440 and dropping the photo list 441 and 442 on the “To Share” photo list 440 creates child relationships for the photo list 441 and 442 and the membership list for the “To Share” photo list 440 is updated to include the multimedia files associated with the photo lists 441 and 442. Accordingly, a top level photo list includes multimedia files that are generally related to a specified activity and the child nodes contain multimedia files relate to specific actions related to the general activity.

In an alternate embodiment of the invention, each node is associated with rules that enable an automatic determination of when a multimedia file should be associated with the node. The membership list of the node is updated to include a reference to the multimedia file when a multimedia file is associated with the node. The rules may be generated by a rules wizard that guides the user when creating and defining a new child node of the photo list node 317. Additionally, rules may also define heuristics to determine when photo list should be merged or nested to create the hierarchies.

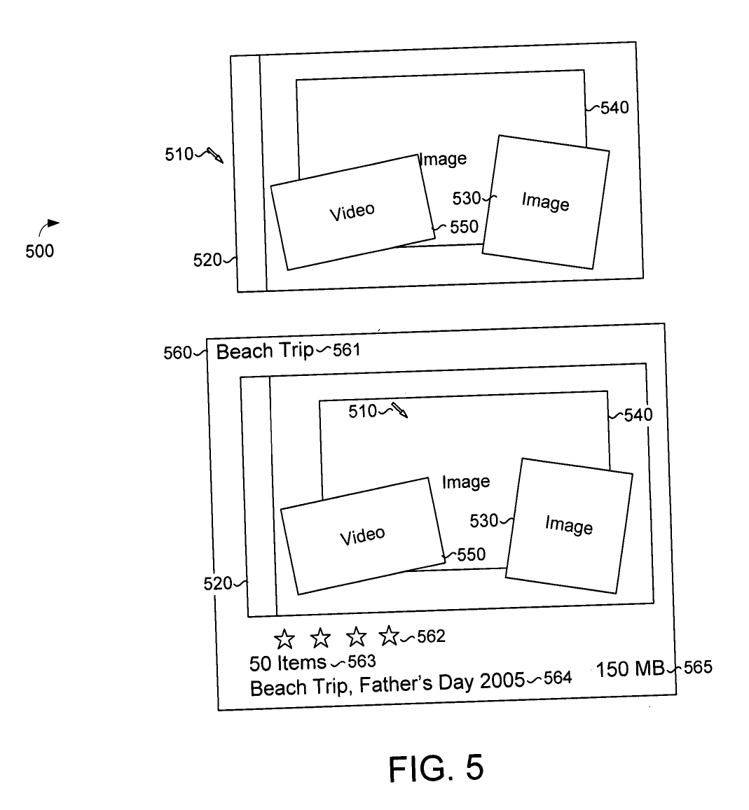

FIG. 5 illustrates a thumbnail 520 of a user workflow list utilized by embodiments of the invention. In an embodiment of the invention, the user workflow list is a photo list having one or more multimedia files. The thumbnail 520 of the user workflow list includes a binder background to indicate that the thumbnail represents a photo list. Additionally, three thumbnails are shown to indicate that the photo list is populated with multimedia files. The thumbnails represent two images 540 and 530 and a video 550. In an embodiment of the invention, the thumbnails of the two images 540 and 530 and the video 550 represent multimedia files that were recently associated with the photo list or recently accessed by the user and stored in the photo list. When a mouse 510 hovers over the thumbnail 520, additional information 560 related to the photo list is displayed to the user. The additional information may include a photo list name 561, rating 562, number of items in the photo list 563, and tags 564 associated with the photo list, and the size 565 of the photo list. Accordingly, the thumbnail 520 may be used as an icon to represent a node having a collection of multimedia files that require an activity to be performed.

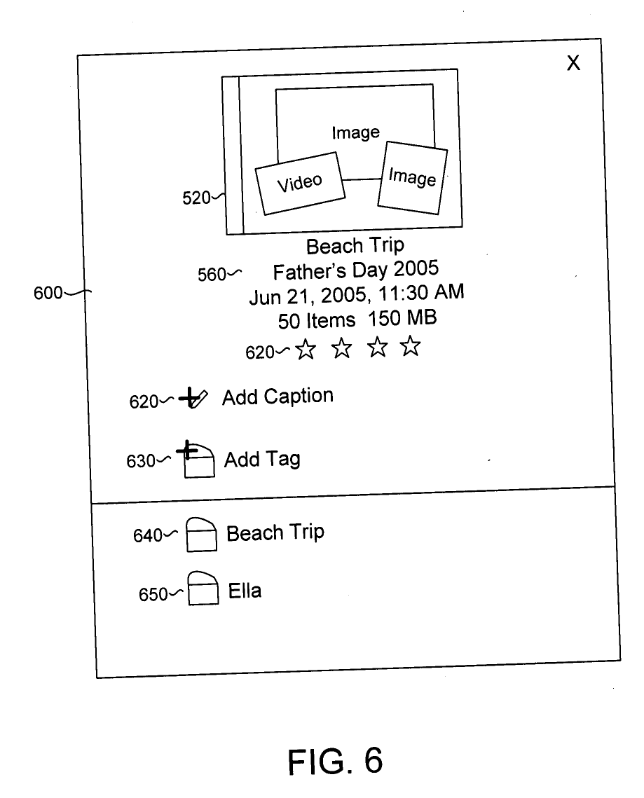

FIG. 6 illustrates a user workflow list properties dialog box 600 utilized by embodiments of the present invention.

The user workflow list properties dialog box 600 provides an additional pane for viewing information about nodes that are selected from the user workflow list hierarchy 400. With reference to FIG. 6, when a photo list node 410-460 is selected the user is provided with a thumbnail 520 representation of the photo list node. Also, the additional information 560 is displayed, and the user may alter the photo list name, the date created, the number of items in the photo list, the user-defined rating of the photo list, the caption for the photo list, and the tags 640-650 that are applied to the photo list. Moreover, the user workflow list properties dialog box 600 enables the user to add new captions or tags utilizing an add caption button 620 or an add tag button 630, respectively. Accordingly, the user workflow list properties dialog box 600 provides the user with the thumbnail 520 for a photo list that includes thumbnails of multimedia files associated with the photo list and the additional information 560, which may be edited by the user.

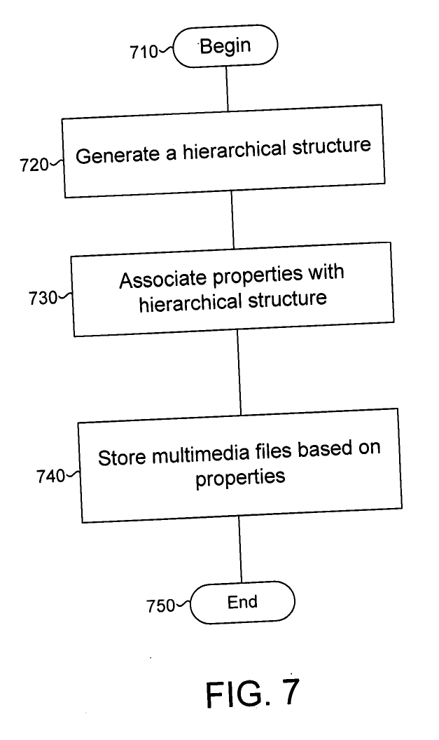

FIG. 7 illustrates a flow diagram of a method to organize multimedia files utilizing the user workflow lists.

The method begins in step 710. The user workflow lists, which represent a hierarchy of nodes, are generated in step 720 in response to a user request to create one or more new nodes. The one or more new nodes may be a list item or container for one or more multimedia files. In step 730, properties are associated with the one or more new nodes. Then, in step 740, multimedia files are stored in the one or more new nodes based on relationships between the properties of the one or more new nodes and the one or more multimedia files. The method ends in step 750.

A user may utilize the create new photo list node 410 to generate the user workflow lists. The create new photo list node 410 creates new nodes and defines the new nodes utilizing activities and properties, such as, for example, optimal display settings, ratings or comments. The activities are properties that define an action to be performed on multimedia files associated with the new nodes, such as, a “To Print” activity. The user may associate multimedia files with the new nodes by dragging a multimedia file from the view section 340 onto the navigations section 310 having the new nodes, which stores a reference to the multimedia file in the user workflow lists. A relationship between the new node and the multimedia files defines the multimedia file as corresponding to an activity for printing. Accordingly, the new node that represents the activity “To Print” stores the multimedia file. In an alternate embodiment of the invention, the new nodes are defined to include rules for determining when a multimedia file should be associated with the node. After the new nodes are defined, multimedia files are associated with the new nodes automatically based on the rules associated with the node.

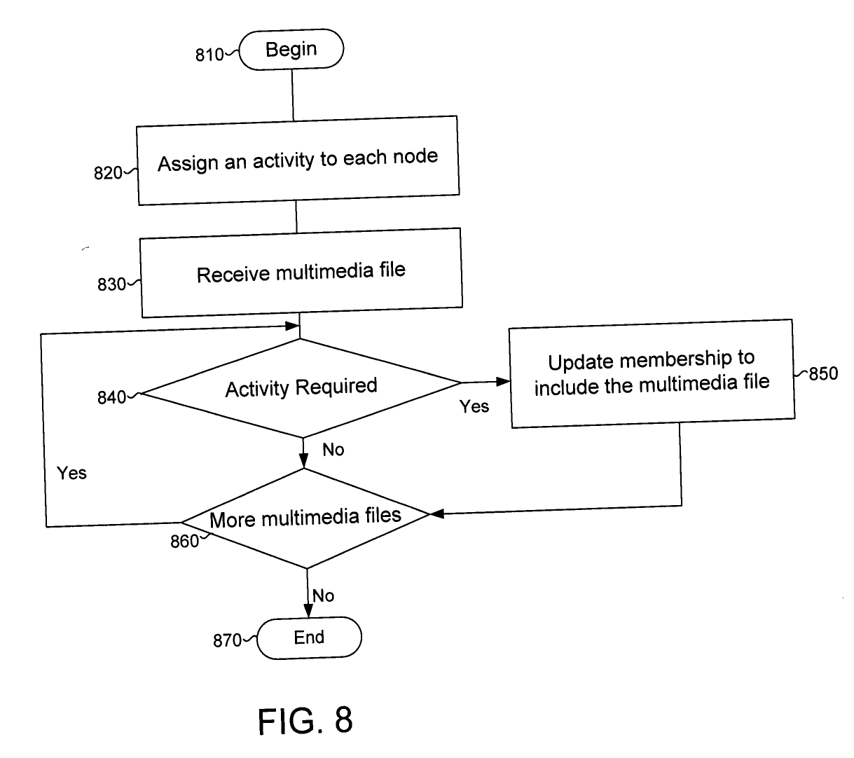

FIG. 8 illustrates a flow diagram of a method to track membership of multimedia files utilizing the user workflow lists.

The method begins in step 810. The user workflow lists include a hierarchy of nodes that are assigned activities in step 820. Multimedia files are received from a source in step 830. In step 840, a determination is made to check whether each multimedia files received requires the activity. When the activity is required, a membership list associated with the node representing the activity is updated to include a reference to the multimedia files in step 850. When the activity is not required, a determination is made to see whether there are multimedia files that have not been checked in step 860. When multimedia files remain, the method executes step 840. The method ends, in step 870, after all multimedia files are checked.

Here, a user may assign new activities to current nodes by renaming the current nodes, or the user can utilize a dynamic activity node to create new nodes in a workflow hierarchy by adding new activities to the workflow hierarchy. Multimedia files may be received from a source, such as, for example, a multimedia database, a camera or camcorder. For each activity, the multimedia files are traversed to determine which multimedia files require the activity. A reference to each multimedia file that requires the activity is included in a membership list associated with the node corresponding to the required activity. Accordingly, the multimedia files may be organized based on the activities associated with each node.

In sum, user workflow lists provide a hierarchy that efficiently organizes multimedia files based on properties or activities to be performed by the user or a computer. The activities are associated with nodes in the hierarchy, and properties of each node can be utilized to efficiently organize and display the multimedia files. Alternative embodiments of the invention provide a graphical user interface having a navigation tree including nodes that relate to activities, and a multimedia view to render the multimedia files. Each node in the navigation tree may represent an activity to be performed on one or more multimedia files. The graphical user interface also provides a thumbnail of each node that represents activities associated with one or more multimedia files. The thumbnail includes a composite image of one or more multimedia files that are associated with the node. Accordingly, embodiments of the invention provide efficient techniques to access multimedia files based on properties or activities, where different applications may utilize the user workflow lists to access and manipulate the multimedia files.

The foregoing descriptions of the invention are illustrative, and modifications in configuration and implementation will occur to persons skilled in the art. For instance, while the present invention has generally been described with relation to FIGS. 1-8, those descriptions are exemplary. Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. The scope of the invention is accordingly intended to be limited only by the following claims.

We claim:

1. A method to organize multimedia files, the method comprising:
generating a hierarchy having a plurality of containers;
associating a plurality of properties with each container in the hierarchy; and
storing multimedia files in one or more containers based on one or more relationships between the multimedia file and the plurality of properties.

2. The method according to claim 1, wherein one or more properties of the plurality of properties associated with the container represent one or more activities.

3. The method according to claim 1, wherein the plurality of containers in the hierarchy are nodes in a tree structure.

4. The method according to claim 3, wherein the plurality of nodes in the tree structure are lists.

5. The method according to claim 4, wherein the lists store the multimedia files.

6. The method according to claim 5, wherein the lists store pointers to the multimedia files.

7. A computer system configured to execute instructions that perform the method according to claim 1.

8. A method to track membership of one or more multimedia files in a hierarchical structure having a plurality of nodes, the method comprising:
assigning an activity to each node in the hierarchical structure;
file requires one or more activities.

9. The method according to claim 8, wherein updating the membership list comprises:
storing a pointer to the multimedia file in the membership list.

10. The method according to claim 8, wherein each node represents a list.

11. The method according to claim 8, wherein the hierarchical structure is implemented by a XML file.

12. The method according to claim 8, wherein the hierarchical structure includes a generic node that creates specialized nodes.

13. The method according to claim 12, wherein the specialized nodes are associated with one or more activities.

14. A computer system configured to execute instructions that perform the method according to claim 8.

15. A computer readable medium storing a data structure that efficiently organizes multimedia files, the data structure comprising:
a hierarchical structure having nodes that represent activities to be performed on the multimedia files;
a dynamic activity node that generates the activities associated with the nodes of the hierarchical structure; and
a membership list storing references to each multimedia file requiring one or more of the activities.

16. The computer readable medium according to claim 15, further comprising:
properties that define the nodes in the hierarchical structure.

17. The computer readable medium according to claim 15, wherein the nodes are lists.

18. The computer readable medium according to claim 17, wherein the lists include metadata.

19. The computer readable medium according to claim 18, wherein the metadata includes a rating associated with the multimedia file.

20. A computer system having memory configured to store the computer readable medium according to claim 15.
